(19) United States
(12) Patent Application Publication
(10) Pub. No.: US 2016/0257584 A1
(43) Pub. Date: Sep. 8, 2016

(54) SYSTEMS AND METHODS FOR TREATING NON-POINT SOURCE POLLUTANTS IN WATER RUNOFF USING SLOW-RELEASE AGENTS

(71) Applicant: OHIO UNIVERSITY, Athens, OH (US)

(72) Inventors: Eung Seok Lee, Athens, OH (US); Yongje Kim, Daejon (KR)

(21) Appl. No.: 15/032,797

(22) PCT Filed: Oct. 29, 2014
(86) PCT No.: PCT/US14/62937

§ 371 Date: Apr. 28, 2016

Related U.S. Application Data
(60) Provisional application No. 61/897,007, filed on Oct. 29, 2013.

(51) Int. Cl. C02F 1/72

(52) U.S. Cl. CPC C02F 1/722; C02F 1/72; C02F 2305/026; C02F 2307/08; C02F 2101/32

(57) ABSTRACT

A slow-release method for treating non-point source pollutants traveling in water runoff, such as urban water runoff. Method embodiments include the use of slow-release advanced oxidation process forms (SR-AOPs) comprised of one or more water soluble salts in a matrix and/or forms producing hydrogen peroxide, persulfate anion, and/or permanganate. One or more of such forms may be placed along with one or more slow-release iron forms in the path of runoff water as it flows through a storm sewer system, such that an amount of the water soluble salt(s) and/or hydroxyl radicals (Fenton's reagent), persulfate radicals, or permanganate are slowly released into the runoff water to oxidize the pollutants contained therein.

### TECHNICAL FIELD

Embodiments of the invention are directed to the treatment of pollutants in runoff water.

### BACKGROUND

A variety of toxic substances can occur as non-point source (NPS) watershed contaminants, especially in urban watersheds. Common pollutant sources in such an environment include, for example, the atmospheric deposition of metals and nutrients, the wash-off of organics and trace metals from roads, parking lots, roof tops, construction sites, etc., and the intensive NPS releases of chemicals of all types. It has been estimated that annually in the United States, 4.9×10⁹ liters of automobile and industrial waste products are introduced into the environment either by direct disposal into sewers or accidental spillage or leakage. (See Tsihrintzis et al., 1997). It has also been estimated that parking lots are the leading source of surface water NPS contamination with a load bearing that is 25 times higher than that of residential areas (Id.). Contamination of surface runoff by organic compounds from sidewalks, roads and parking lots is accelerated by the impermeable surfaces thereof, which inhibit infiltration of rain water into the subsurface. High contaminant concentrations occur after long periods (e.g., weeks to months) of little to no precipitation, which causes the contaminants to accumulate on the impermeable surfaces until a rainfall event occurs.

Some of the toxic substances that may appear include, without limitation, Polycyclic Aromatic Hydrocarbon (PAH) materials, and gasoline constituents and byproducts such as Benzene, Toluene, Ethylbenzene and Xylene-o,m,p (BTEX) or methyl tertiary butyl-ether (MTBE). Substances such as PAH, BTEX and MTBE are now garnering more attention due largely to their resistance to biodegradation, high detection frequency, and toxicity. Studies have shown that these organic NPS contaminants significantly impair the hydrologic and biologic function of urban water systems and human health. (See e.g., Urban Storm Water: Best Management Practices EPA-821-R-99-012 US EPA, 2002).

The treatment of NPS contamination in urban runoff can be difficult because, for one, such runoff is typically characterized by what may be referred to as the first flush phenomenon. The first flush phenomenon recognizes that there is a greater discharge rate of NPS pollutant mass earlier in a large runoff volume than there is later. There are several factors that can influence first flush events, including but not limited to land use type, intensity and length of storm event, and duration of dry weather prior to the storm event (See e.g., Gupta and Saul, 1996). In addition, storm sewer systems are designed to, and quickly drain storm water to designated receiving water bodies. For example, testing has revealed that a completely full storm sewer pipe three feet in diameter and 2,000 feet in length, can discharge all the storm water contained therein within approximately 3.5 minutes. Consequently, it can be understood that a system and method for treating urban NPS contamination by a chemical approach must include both space for high water flow rates and adequate contact time for chemical reactions—a seemingly contradictory set of design goals.

While there has been technological progress in the development of the best management practices, such as infiltration swales and pervious pavements, reducing NPS loads to urban aquatic systems remains a challenge because of the ubiquitous pollutant sources, the first flush phenomenon, and the short residence times within which the runoff can be treated. Therefore, there remains a need for a new approach that can reduce pollutants in urban runoff in a cost-effective manner.

### SUMMARY

Embodiments of the invention are directed to novel, on-site water runoff treatment systems and methods. Embodiments of the invention may make use of a slow release system (SRS) and urban storm sewers to degrade organic carbon substances and metals present in urban water runoff. Certain embodiments of the invention employ advanced oxidation processes (AOPs) and slow-release AOP agents to treat water runoff. Other embodiments of the invention employ a novel slow-release Fenton's reagent to treat water runoff. Systems and methods employing a combination of slow-release AOP agents and slow-release Fenton's reagent is also possible. In a preliminary study of the inventive technology, BTEX and a simple PAH substance (i.e., naphthalene) were chosen as target pollutants.

Advanced Oxidation Processes are chemical processes that use various oxidants or oxidant combinations to produce highly reactive radicals. These radicals may be used to mineralize the organic compounds commonly found in urban runoff. AOP agents such as hydrogen peroxide (H₂O₂) and persulfate anions (S₂O₈²⁻) have especially high oxidation potentials that can be further activated by iron.

Soluble salts are available for the production of SRS forms. Exemplary types of such soluble salts include, without limitation, sodium persulfate (Na₂S₂O₈), ferrous sulfate heptahydrate (FeSO₄.7H₂O), sodium percarbonate (Na₂CO₃), hydrogen peroxide, and sodium hydroxide (NaOH). Forms of slow-release persulfate (SR-PS), slow-release hydrogen peroxide (SR-HP), slow-release hydroxide (SR-OH) and slow-release iron (SR-Fe) may be developed by mixing selected salt grains with wax or a resin in a mold.

When hydrogen peroxide is activated by iron, a hydroxyl radical (OH^{}) is generated to yield a Fenton process. The hydroxyl radical has an unpaired electron making it a highly reactive, relatively nonspecific oxidant that reacts with most contaminants of concern, including aromatic hydrocarbon compounds.

The combination of a solution of hydrogen peroxide and an iron catalyst is known as Fenton's reagent, and would be quite familiar to one of ordinary skill in the art. Fenton's reagent is effective at oxidizing organic compounds, such as organic compounds found in water runoff. However, known Fenton's reagent is difficult to handle and transport due to its liquid state, and is also very highly reactive. Consequently, the invention includes, among other things, a novel non-liquid, slow-release Fenton's reagent that overcomes these problems, and water runoff treatment systems and methods that employ the slow-release Fenton's reagent.

The efficiency of Fenton processes is affected by pH, the existence of Iron ions (Fe²⁺) and the molar ratio between oxidant and contaminant. Reduced irons such as Fe⁰ and Fe²⁺ ions are much more efficient than Fe³⁺ ions in producing hydroxyl radicals. It is known that persulfate (S₂O₈²⁻) can be activated by chemical or thermal reaction, such as high temperature, base, Fe²⁺ ions and hydrogen peroxide. It is also known that persulfate activation with Fe²⁺ ions requires lower activation energy than does thermal activation, and has high removal efficiency for contaminants such as trichloroethylene (TCE), BTEX and MTBE. Like hydrogen peroxide, the efficiency of persulfate oxidation is influenced by pH, the existence of Fe²⁺ ions, and the molar ratio between oxidant and pollutants.

A slow-release system can release certain constituents at a rate which is predetermined by the design of the system for a definite time period. Therefore, slow-release systems may be effectively used to treat periodically occurring and fast-flowing water streams, such as urban water runoff.

Other aspects and features of the invention will become apparent to those skilled in the art upon review of the following detailed description of exemplary embodiments along with the accompanying drawing figures.

### BRIEF DESCRIPTION OF THE DRAWINGS

In the following descriptions of the drawings and exemplary embodiments, like reference numerals across the several views refer to identical or equivalent features, and:

FIG. 1 represents an exemplary bench-top system for producing slow-release advanced oxidation process (AOP) forms for testing purposes;

FIGS. 2A-2E graphically depicts the temporal changes in the removal rates by various slow-release AOP agents of a number of different pollutants from a water sample;

FIG. 3 schematically represents the placement of multiple slow-release AOP forms in storm drains (inlets) of a storm sewer system;

FIG. 4 depicts several exemplary embodiments of slow-release AOP forms;

FIGS. 5A-5D illustrate how hydrogen peroxide concentration increases along with increased SR-AOP salt-to-wax mixing ratios at a given flow rate;

FIGS. 6A-6B graphically illustrate how the release rates of (A) exemplary slow-release hydrogen peroxide and (B) exemplary slow-release persulfate forms increase along with increased salt-to-wax mixing ratios at a given flow rate;

FIG. 7 depicts an exemplary embodiment of a flow-through testing apparatus;

FIG. 8 is a Table listing the contact times between various SR-AOP forms and treated water during testing;

FIG. 9 graphically illustrates pollutant removal rates achieved during testing after a 20 minute contact time with slow-release persulfate AOP forms and slow-release iron AOP forms;

FIG. 10 represents an exemplary bench-top system for the oxidation testing of exemplary SR-AOP forms;

FIGS. 11A-11E graphically illustrate the release rate profiles of various SR-PS forms with oxidant to wax ratios

FIG. 12 is a graph showing the effectiveness of pollutant removal as demonstrated by flow-through tests using slow-release persulfate and slow-release hydroxide forms in deionized water;

FIG. 13 is a graph showing the effectiveness of pollutant removal as demonstrated by flow-through tests using a combination of slow-release persulfate, slow-release hydroxide, and slow-release hydrogen peroxide forms in both deionized and runoff (storm) water;

FIGS. 14A and 14B illustrate an exemplary site selected for field baseline testing of water runoff;

FIGS. 15A and 15B graphically present water runoff discharge rates and TOC concentration levels observed at a monitored storm pipe during two separate storm events;

FIGS. 16A and 16B graphically present water runoff discharge rates and chloride concentration levels observed at a monitored storm pipe during two separate storm events; and

FIGS. 17A and 17B graphically present water runoff discharge rates and sulfate concentration levels observed at a monitored storm pipe during two separate storm events.

### DETAILED DESCRIPTION OF EXEMPLARY EMBODIMENT(S)

An on-site remedial scheme for NPS pollutants in urban storm runoff should provide for the fast drainage of storm water and for adequate contact time for chemical reactions—a seemingly contradictory set of design goals. Considering the prevalent contaminant sources, first flush phenomenon, low pollutant concentrations, and need for the quick drainage of storm water, installations of active treatment systems or constructions of new infrastructure for storage is cost prohibitive. Consequently, embodiments of the invention are directed to the use of semi-passive slow-release systems to supply oxidants to water runoff in a controlled and persistent manner. Urban storm pipe systems may be used to provide the contact time necessary for oxidation while still facilitating the quick discharge of storm water to the receiving water bodies.

The term slow release (SR) as used herein is meant to describe the technique of introducing a given compound into a system to be treated at a reduced rate. That is, as opposed to the rapid introduction of a single large dose of a compound, a slow-release technique opts to provide a similar dosage by diffusing smaller quantities of the compound into the system over an extended period of time. As an analogy, one likely familiar slow release strategy is the measured introduction of a drug into the human bloodstream, such as by means of a slow-release tablet.

In the present case, a slow release system (SRS) may be applied to groundwater remediation in the form of, for example, a matrix-type or encapsulated type, slow-release AOP form. One or a collection of such forms may then be located in the path of groundwater runoff for the purpose of treating contaminants entrained therein.

One type of AOP form that is believed to be useful in the slow-release treatment of groundwater runoff is a permanganate SR form. Permanganate SR forms may be manufactured by, for example, dispersing potassium permanganate (KMnO₄) or sodium permanganate (NaMnO₄) salts in matrices such as polymeric matrices of paraffin wax or resin. A matrix comprising a non-reactive sediment, such as silica sand, may also be used. Other types of such forms that are believed to be useful in the slow-release treatment of groundwater runoff include, for example, SR forms manufactured from sodium persulfate and activated sodium persulfate in matrices of paraffin wax or resin, SR forms manufactured from sodium hydroxide in matrices of paraffin wax or resin as well as SR forms manufactured from iron-activated sodium percarbonate (Fenton's reagent) in matrices of paraffin wax or resin. As the salts at the edge of the form matrix dissolve, secondary permeability is created, which allows the slow dissolution and release of salts inside the matrix via diffusion over an extended time period. For example, it is possible to release the salts over a period of months or even years. The use of forms comprising encapsulated material is also possible.

A number of proof-of-concept experiments were performed to demonstrate that SR-AOP forms can release S₂O₈²⁻, OH⁻, H₂O₂ and Fe²⁺ in a consistent and controlled manner, and to test the effectiveness of exemplary SR-AOP forms on remediating contaminated water. In preparation for conducting these tests, reagent-grade sodium persulfate (Na₂S₂O₈, >98%), ferrous sulfate heptahydrate (FeSO₄.7H₂O, ≧99.0%), sodium percarbonate (Na₂CO₃.1.5H₂O₂), and hydrogen peroxide (H₂O₂, 6%) were purchased from Fisher Scientific, having offices in Pittsburgh, Pa. Sodium Hydroxide (NaOH, 98% for analysis) was purchased from Acros Organics having offices in New Jersey. Sodium percarbonate dissolves in water (solubility=150 g L⁻¹ at 25° C.) to release hydrogen peroxide (H₂O₂) and sodium carbonate (Na₂CO₃). Sodium persulfate dissolves in water (solubility=556 g L⁻¹ at 25° C.) to release persulfate (S₂O₈²⁻). Ferrous sulfate heptahydrate dissolves in water (solubility=48.6 g/100 mL at 50° C.) to release iron ions (Fe²⁺).

Also obtained from Fisher Scientific were ascorbic acid (C₆H₈O₆, ≧99.0%) as a quenching agent, cupric sulfate (1%) for use in determining H₂O₂ concentration, sulfuric acid (H₂SO₄) for determining S₂O₈²⁻ concentration, HCl solution (1N) for determining Fe²⁺/Fe concentrations, ferrous ammonium sulfate (FAS, Fe(NH₄)(SO₄)₂6H₂O, 99.4%), Neocuproine (99+%), ethanol (containing 5% 2-Propanol and 5% Methanol), ammonium thiocyanate (NH₄SCN), Hydroxlamine (NH₂OH.HCl, >99%), and 1,10-phenanthroline monohydrate (>99%). Catalase, Coryne bacterium glutamicum (solution, deep brown, ≧500,000 U mL⁻¹), was obtained from Sigma-Aldrich, headquartered in St. Louis Mo. A 47505-U BTEX Mix, HC (2000 μg mL⁻¹ each component in methanol, analytical standard), and naphthalene solution (200 μg mL⁻¹ in methanol, analytical standard) were also purchased from Sigma-Aldrich. Fluorescent FWT Red Dye Tablets were purchased from Forestry Suppliers and used to determine residence time of storm runoff in storm pipes during exemplary field testing. Gulf Wax household paraffin wax was purchased as an exemplary binding agent. Deionized water was produced with a Milli-Q system manufactured by Millipore, located in Billerica, Mass.

The obtained BTEX mix and naphthalene solution concentrations were determined by Cardinal Laboratories (Wilder, Ky.) using test method SW-8468021. All samples were refrigerated until shipment. Persulfate anion, hydrogen peroxide, hydroxide, and iron concentrations were also measured.

### Experiment 1

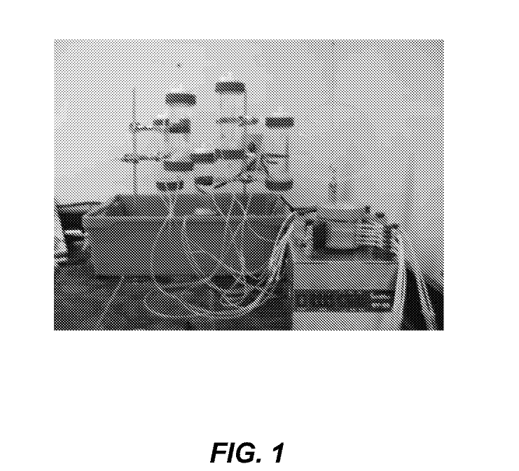

A first experiment was conducted to test the general efficacy of using certain slow-release AOP forms for treating organic pollutants in water runoff. In this regard, slow-release AOP pellets (cylindrical forms) were prepared by mixing soluble salt granules of the selected oxidants with molten paraffin wax in a cylindrical mold having an internal diameter of 2.5 cm. The pellets were then allowed to crystallize at room temperature. (See Lee and Schwartz (2007a, b) in this regard). Various slow-release persulfate (SR-PS) pellets, slow-release hydrogen peroxide (SR-HP) pellets, and slow-release iron (SR-Fe) pellets were respectively produced using salts of sodium persulfate, sodium percarbonate, and ferrous sulfate heptahydrate. To facilitate complete mixing, the mold was continuously rolled and flipped until the molten wax was solidified. The mixing ratios of salts and wax were adjusted to be 3:1 and 5:1. The molding system for producing the pellets is represented by the setup of FIG. 1.

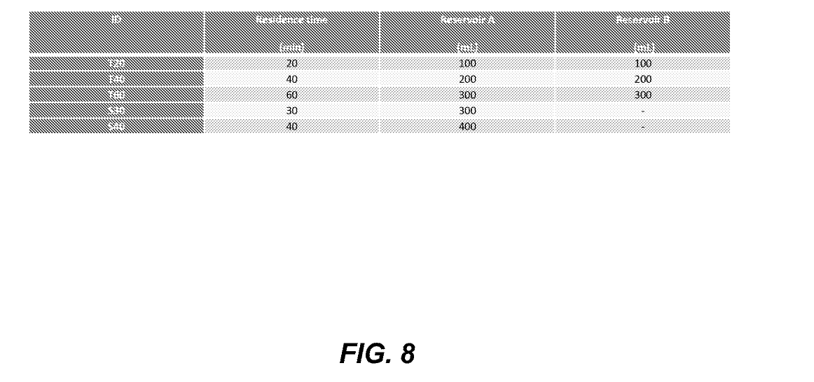

Oxidations of BTEX and naphthalene by persulfate (PS), Fe²⁺ activated persulfate (PS/Fe), H₂O₂ activated persulfate (PS/HP), Fe²⁺ and H₂O₂ activated persulfate (PS/HP/Fe), and Fe²⁺ catalyzed H₂O₂, Fenton's reagent (HP/Fe), were compared through a series of batch experiments. Particularly, proof-of-concept, flow-through testing was performed using the equipment setup of FIG. 8 to simulate the water runoff conditions to which the SR-AOP forms would be exposed in an urban environment. Samples were taken at 0, 5, 10, and 30 minutes. Samples for BTEX analyses were collected in 40 mL vials and 80 μL Catalase and 2 mL of 30 g L⁻¹ ascorbic acid were added immediately to quench H₂O₂ and persulfate anion/radicals, respectively. Removal rates of BTEX and naphthalene by PS, PS/HP, PS/Fe, HP/Fe, and PS/HP/Fe were monitored over 30 minutes of contact time. This contact time is believed to approximate the maximum residence time of storm runoff in a typical storm pipe of approximately 1,800 feet in length with a flow velocity of approximately 20 m min⁻¹. The results of these batch oxidation experiments are discussed below.

The release rates of the produced slow-release pellets were measured by column testing using glass columns (ID×L=4.8 cm×15 cm). Peristaltic pumps (from Ismatec) were used to maintain water flow rates at 4 mL min⁻¹, 8 mL min⁻¹, and 12 mL min⁻¹ over testing periods of seven days. Flow rates were measured during each sampling period to obtain net release rates of the slow-release forms.

A control sample (without oxidants) was used to estimate the loss of BTEX and naphthalene by evaporation alone in the batch tests. An amount of ferrous sulfate heptahydrate salt was also added at the beginning of the test as an instantaneous source of iron ions (Fe²⁺). With respect to the control sample, it was found that approximately 10% of the BTEX and approximately 2% of the naphthalene was lost within 10 minutes due to evaporation. These values were subtracted from the measured removal rates of the samples with AOP agents.

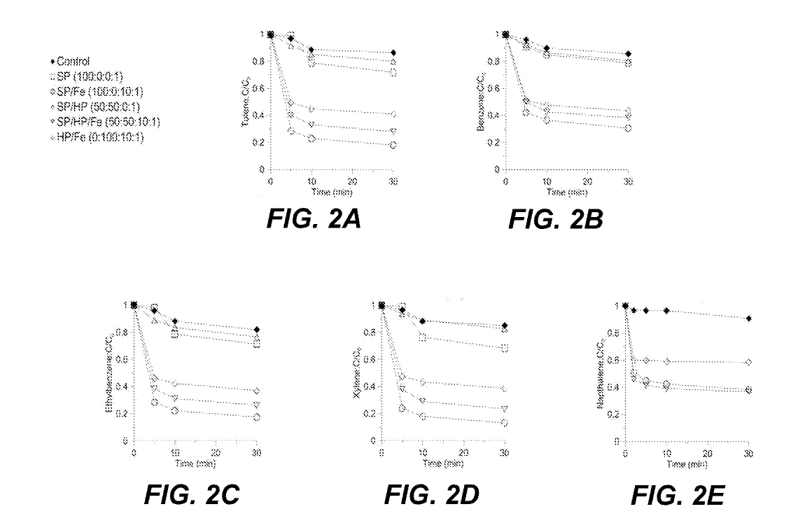

Overall, Fe²⁺-activated AOP agents (e.g., PS/Fe, HP/Fe, PS/HP/Fe) showed much greater removal rates than PS and HP/PS, indicating active production of OH^{} and SO₄^{-}. The temporal changes in the removal rates of naphthalene and the individual BTEX compounds (benzene, toluene, ethylbenzene and xylene) by the SR-AOP test pellets during flow-through testing are presented in FIGS. 2A-2E. Note that the ratios enclosed by the parentheticals in the symbol key associated with FIGS. 2A-2E represent the ratios of PS:HP:Fe:pollutants for the given AOP.

The batch testing revealed that for BTEX, PS/Fe yielded the best removal efficiencies among the tested AOP agents. Removal efficiencies ranged between about 48% to 67% at a 5 minute contact time, between about 53% to 72% at a 10 minute contact time, and between about 60% to 77% at a 30 minute contact time. The BTEX removal efficiencies of HP/PS/Fe were also good, being as high as about 52% for a 5 minute contact time, as high as about 60% for a 10 minute contact time, and as high as about 64% for a 30 minute contact time. While not as efficient as PS/Fe or HP/PS/Fe, HP/Fe also produced promising BTEX removal efficiencies of up to about 42%, 45% and 50% for respective contact times of 5 minutes, 10 minutes, and 30 minutes. The removal efficiencies of PS and PS/HP were more limited, respectively removing up to about 19% and up to about 10% of BTEX within 30 minutes of contact therewith.

Generally speaking, removal rates were the greatest during approximately the first 5 minutes of contact, then rapidly decreased, resulting in little changes in the removal rates during the rest of the testing period. Such an asymptotic decrease in oxidation rates was attributed to the rapid conversion of Fe²⁺ iron ions to Fe³⁺ iron ions during the oxidation reactions.

For naphthalene, PS/Fe and PS/HP/Fe showed the best removal efficiencies, ranging between about 47% and 54% within 2 minutes of contact, between about 52% and 57% within 5 minutes of contact, between about 56% and 58% within 10 minutes of contact, and between about 58% and 59% within 30 minutes of contact. The removal efficiency of PS/HP/Fe was slightly greater than PS/Fe, indicating that persulfate can further facilitate HP/Fe oxidation. The naphthalene removal efficiencies of PS/HP/Fe and PS/Fe were the greatest during the first 2 minutes after contact, then rapidly decreased, yielding less than a 10% removal efficiency during the remainder of the testing period. This observation was in keeping with the oxidation of BTEX, and likewise, the rapid decrease in removal rates was attributed to active conversion of Fe²⁺ iron ions to Fe³⁺ iron ions.

Among the tested SR-AOP agents, PS/Fe and PS/HP/Fe yielded the best removal efficiencies for BTEX and naphthalene, which were rapidly attenuated within about 2 to 5 minutes of contact. This suggests that while PS/Fe or PS/HP/Fe exhibited excellent oxidation kinetics, removal rates could be further increased if the oxidants and Fe²⁺ iron ions are continuously supplied to the contaminated water. Consequently, the value of using a slow-release system to continuously release oxidants and Fe²⁺ iron ions to fast-flowing storm water within a storm pipe should be apparent.

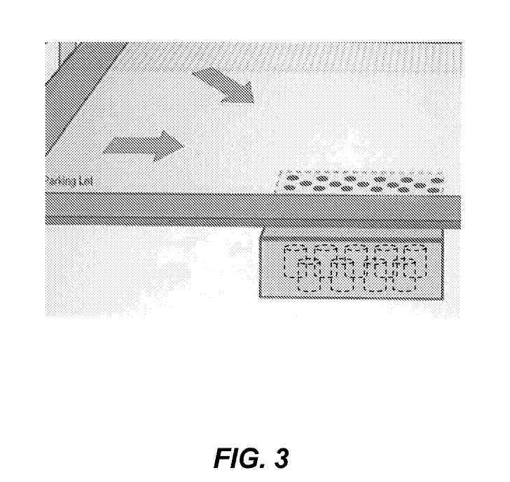

Furthermore, as suggested by FIG. 3, it should also be understood that multiple slow-release AOP forms may be placed in storm drains (inlets) at various locations to provide sufficient AOP mass to treat an entire storm pipe system. Forms may also be placed at other locations for the same purpose, such as within storm pipes when possible, and/or at storm pipe outlets or other locations where runoff will contact the forms.

It has been determined that the main constraints on the release rates and durations of matrix-type slow-release systems are the solubility of the salts used and the effective diffusion coefficient (Dₑ) of the matrix. Here, the Dₑ values are constrained by the mixing ratios of the soluble salt and inert matrix, as well as the pattern of initial salt loadings.

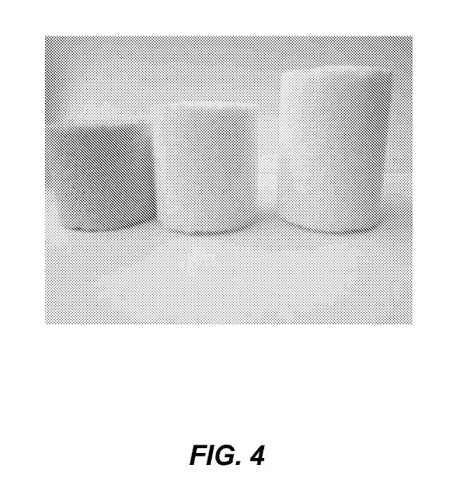

Based on the results of Experiment 1 and the above-described release rate and duration constraints, slow-release persulfate (SR-PS), slow-release hydrogen peroxide (SR-HP), and slow-release iron Fe²⁺ (SR-Fe) forms were manufactured for the purpose of further experimentation and investigation regarding the specific release characteristics of slow-release forms. For this investigation, a single-component, matrix-type, monolithic slow-release system was used (i.e., each salt was separately dispersed in a wax matrix). This allows the release rates of a given slow-release system to be adjusted by changing mixing ratios. Exemplary embodiments of the slow-release forms used in the experiment/investigation are shown in FIG. 4.

### Experiment 2

In furtherance of investigating the specific release characteristics of slow-release forms, tests were performed on four manufactured SR-HP pellets (cylindrical forms) having an outside diameter of approximately 3.4 cm and a length of approximately 4.5 cm. The pellets had different salt-to-wax mixing ratios, the ratios being about 2:1, 3:1, 4:1 and 5:1, respectively.

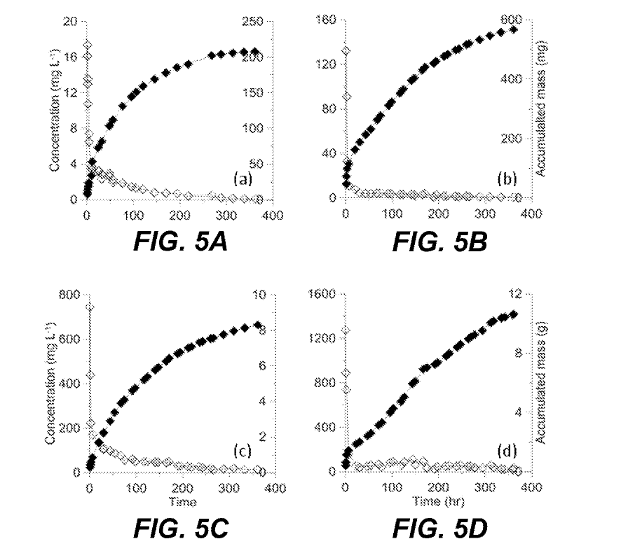

Over 350 hours of column testing was conducted on the pellets at a fixed flow rate of 8 mL min⁻¹. The test results are shown in FIGS. 5A-5D. Testing revealed that the release patterns of the pellets were characterized by an initial peak concentration spike followed by exponential decay and gradual attenuation. Overall, the strengths of the initial concentration spikes during the first 3 hours of testing increased with increasing mixing ratios. The peak concentrations were 17.5 mg L⁻¹ for the SR-HP form with a mixing ratio of 2:1, 125 mg L⁻¹ for the SR-HP form with a mixing ratio of 3:1, 750 mg L⁻¹ for the SR-HP form with a mixing ratio of 4:1, and 1,280 mg L⁻¹ for the SR-HP form with a mixing ratio of 5:1.

When the initial concentration spike periods ended at approximately 50 hours after test initiation, the hydrogen peroxide concentrations exponentially decreased before being stabilized around an average value. As graphically represented in FIGS. 5A-5D, the average concentrations increased with mixing ratio, from about 1 mg L⁻¹ (at a 2:1 mixing ratio) to about 15 mg L⁻¹ (at a 5:1 mixing ratio). Temporal changes in the hydrogen peroxide concentrations in the column outflow samples are also represented in FIGS. 5A-5D.

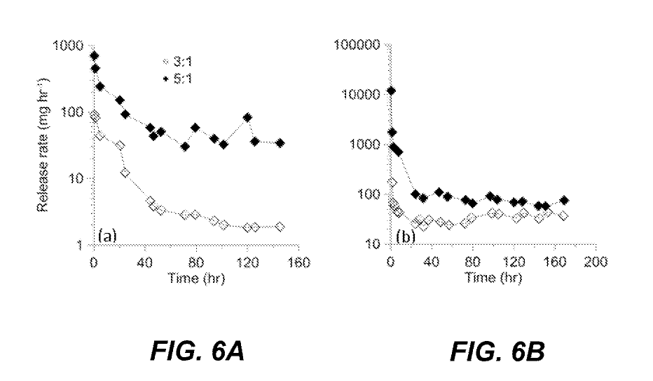

To further investigate the impact of the solubility of salts and flow rates on release rates, column tests were additionally conducted on SR-HP and SR-PS pellets with mixing ratios of 3:1 and 5:1 at an increased flow rate of 12 mL min⁻¹. Over a testing period of 150 hours, initial peak release rates of 90 mg h⁻¹ (at a 3:1 mixing ratio) and 698 mg h⁻¹ (at a 5:1 mixing ratio) were observed for SR-HP. These initial peak release rates exponentially decreased to yield average release rates of 2.5 mg h⁻¹ (at a 3:1 mixing ratio) and 40 mg h⁻¹ (at a 5:1 mixing ratio) after approximately 45 hours. This temporal change in the release rate is presented in FIG. 6A. These values were similar to the release rate data observed for the SR-HP forms at a lesser flow rate of 8 mL min⁻¹, suggesting that flow rate does not significantly affect release rates under the fast flow conditions.

The rather insignificant effect of a fast flow rate on AOP release rate may provide the perfect sink condition to the SR forms. In other words, the oxidant concentrations in the water immediately around the SR forms can be assumed to be zero. This condition can be attributed to the concentration gradient (i.e., the difference in concentrations between the interior of the SR forms and the outer shell of the slow-release forms). The release rate of a SRS form will increase with an increase in the concentration gradient. Consequently, when the oxidant concentration in water immediately adjacent to a SRS form is increased, the release rate will decrease because the concentration gradient will decrease.

SR-PS was also tested in the same manner over a period of 170 hours. The initial peak release rates for SR-PS were observed to be 200 mg h⁻¹ (at a 3:1 mixing ratio) and 12,550 mg h⁻¹ (at a 5:1 mixing ratio), but exponentially decreased to yield average values of 30 mg h⁻¹ (at a 3:1 mixing ratio) and 93 mg h⁻¹ (at a 5:1 mixing ratio) after approximately 30 hours (see FIG. 6B).

The higher release rates observed for the SR-PS were attributed to higher salt solubility (i.e., Na₂S₂O₈=556 g L⁻¹; Na₂CO₃.1.5H₂O₂=150 g L⁻¹ at 25° C.). More soluble salts create larger concentration gradients in the secondary permeability created within the slow-release forms, facilitating faster diffusive transport of dissolved salts from within the forms toward the outer boundary. When installed at, for example, storm drains, the SR-HP and SR-PS forms could efficiently supply oxidants to the storm runoff in a controlled and persistent manner (e.g., for years).

### Experiment 3

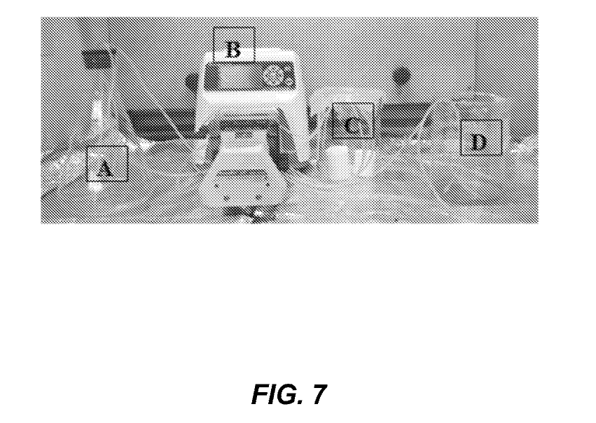

A flow-through bench-top experiment was additionally conducted to evaluate the efficacy of the proposed scheme of using certain slow-release AOP agents and storm pipes to oxidize non-point source pollutants in urban storm runoff. Particularly, SR-PS and SR-Fe forms were emplaced in the sealed containers (reservoirs) shown in the setup of FIG. 7. A dilute solution of BTEX and naphthalene was then flowed through the sealed reservoirs at variable flow rates that yielded 20 minutes, 40 minutes, and 60 minutes of contact time with the SR-PS/Fe forms, as indicated in the table of FIG. 8. The concentration of naphthalene and BTEX was maintained to be low at 200 μg/L so as to approximate the dilute nature of storm water runoff. Samples were taken from the effluent and sent to Cardinal Laboratories for analyses of BTEX and naphthalene concentrations.

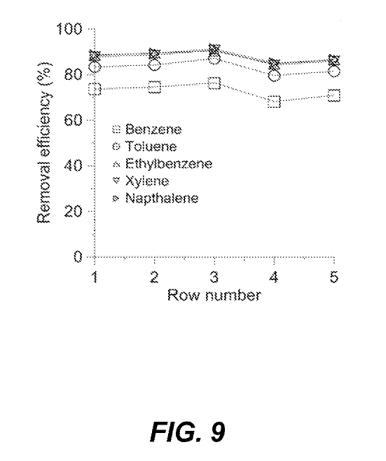

The results of this analyses are graphically illustrated in FIG. 9. As represented, a 20 minute contact time with the SR-PS/Fe forms resulted in removal rates of up to about 73% for benzene, 83% for toluene, 89% for ethylbenzene, 88% for xylene, and 89% for naphthalene. The slightly higher removal rates seen during this experiment in comparison with the batch test data of FIGS. 2A-3E are attributed to the continuous supply of oxidant and Fe²⁺ ions using the slow-release forms. When residence times increased from 20 minutes to 60 minutes while using two SR-Fe forms, the removal efficiencies for benzene, toluene, ethylbenzene, xylene, and naphthalene increased only slightly to 75%, 87%, 90%, 91%, and 91%, respectively. Also, compared to the use of a single SR-Fe form with a 30 minute residence time, the removal efficiencies when using a single SR-Fe form with a 40 minute residence time increased by only approximately 2%.

Overall, it was observed that the increased residence time yielded only slightly increased pollutant removal efficiency. This suggests that the oxidation capacity of the PS/Fe may be reached within about 20 minutes, thus a SR-AOP form residence time within a runoff flow (e.g., in a storm sewer pipe) of as little as about 20 minutes could be sufficient for the SR-PS/Fe scheme to achieve optimal remedial efficiencies with respect to BTEX compounds and naphthalene.

### Experiment 4

An additional release rate experiment was conducted on the SR-PS, SR-HP and SR-Fe forms described above in Experiment 1. The release rates of the produced slow-release forms were again measured by column testing utilizing glass columns (ID×L=4.8 cm×15 cm), with peristaltic pumps used to maintain selected steady flow rates. Samples were collected at fixed intervals from the produced effluent and kept in sampling vials. Test durations were up to 3 weeks.

Samples were analyzed for oxidant concentration using a photospectrometer (Shimadzu 1800) to determine mass flux and release rates. H₂O₂ concentration was determined using the Copper-DMP method described in Baga et al. (1988). The S₂O₈²⁻ concentration was made according to the UV spectrophotometric method described in Huang et al. (2002).

A determination of OH⁻ concentration was based on the relationship between pH and pOH (Eq. 1). An effluent sample from SR-OH column tests was taken over a time of 3 minutes. The effluent sample was then tested for pH level using a Model IQ150 Handheld pH/mV/Temperature Meter (IQ). The pH meter was calibrated before testing each sample using a two point calibration. Once the meter had stabilized for at least 5 seconds on a pH value, pH readings were taken. Once the pH value was taken, the value was then converted to concentration with respect to OH⁻ (Eq. 2).

pH+pOH=14 (1)

pOH=−log [OH⁻] (2)

### Experiment 5

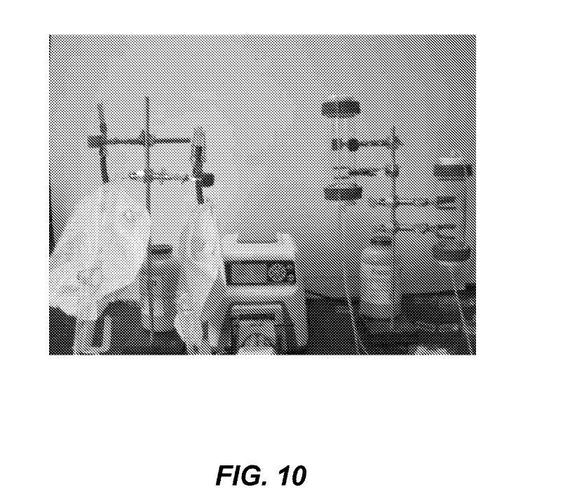

Proof-of-concept oxidation tests were also conducted on SR-OH and SR-HP forms manufactured so that the release rate is optimal for pollutant oxidation and placed in glass columns (e.g., Chromoflex columns of L=15 cm×ID=4.8 cm) to simulate the flow conditions in a storm pipe. The apparatus employed for this oxidation testing is shown in FIG. 10 and utilized two columns. One column of the testing apparatus contained the SR-PS and SR-OH forms, while the other column contained SR-PS, SR-OH and SR-HP forms. Pollutant solutions were made using BTEX/MTBE and PAH standard solutions (Sigma Haldrich). Solutions were made in deionized water as well as storm water collected during baseline sampling (see below). Solutions were mixed in 2 L volumetric flasks. Prior to the test, water was removed from the columns containing the slow-release forms and replaced with pollutant solution. The remainder of the pollutant solution was carefully poured into two urinary catheter bags in order to minimize interactions between the pollutant solution and the air.

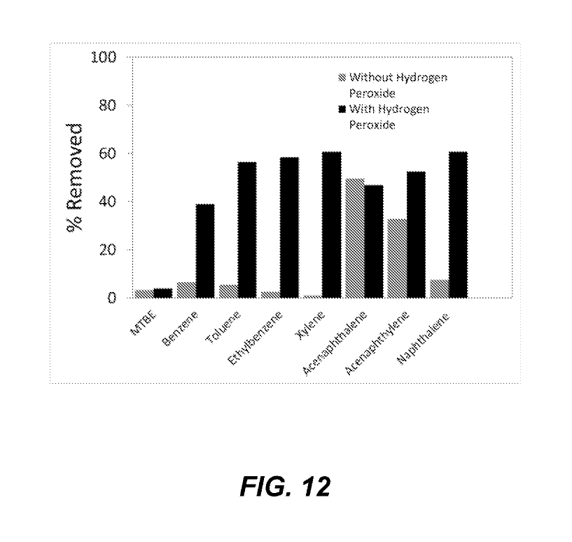

Solution was pumped from both urinary catheter bags simultaneously. Solution from the first bag was pumped into a column containing the slow-release forms while the solution in the second bag was pumped into a column with only water to serve as a control. Pumping rates were maintained at 7 mL min-1 in the test apparatus to maintain a 30-minute residence time. Samples were taken after an hour of flow from both the control effluent and the slow-release form test effluent. Sample vials were covered with plastic wrap in order to limit the interactions between the sample solution and the air. Samples were refrigerated and sent to a commercial lab the following day for analysis. The results of this analyses are graphically represented in FIG. 12.

### Experiment 6

Further column flow-through tests were performed to characterize and compare the release and recovery rates of SR-PS forms having different salt to wax ratios. Particularly, salt:wax ratios of 2:1, 3:1, 4:1, 4.5:1, and 5:1 were used during this testing. The release rates of these various SR-PS forms were again measured by passing water at a known flow rate over the forms while the forms were located in glass columns.

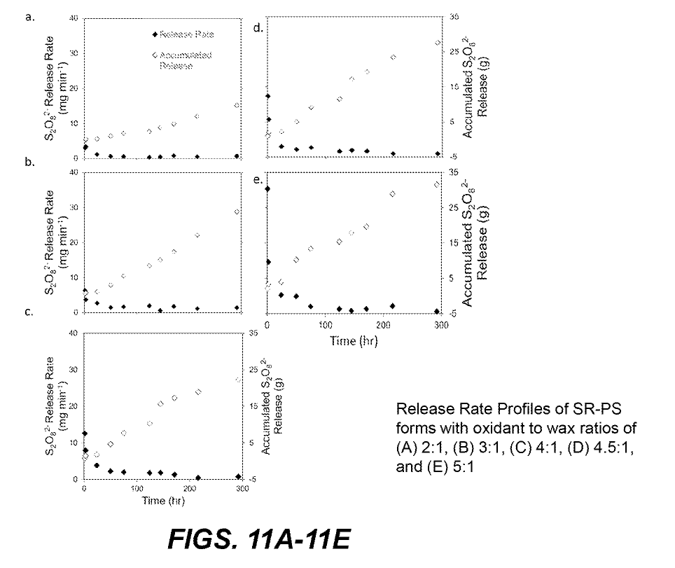

Outflow samples were collected until concentrations were below the reporting limit (5, 4, and 0.1-1 μg/L for BTEX, MTBE, and PAHs, respectively). As graphically represented in FIG. 11, peak release rate values were found to increase as the ratio of salt to wax increases. The peak release rates for the SR-PS forms were found to be 3.0 mg/min for the SR-PS form with a salt:wax ratio of 2:1; 6.3 mg/min for the SR-PS form with a salt:wax ratio of 3:1; 12.6 mg/min for the SR-PS form with a salt:wax ratio of 4:1; 17.4 mg/min for the SR-PS form with a salt:wax ratio of 4.5:1; and 35.4 mg/min for the SR-PS form with a salt:wax ratio of 5:1. Stable release rates for the SR-PS forms were found to be 0.4 mg/min for the SR-PS form with a salt:wax ratio of 2:1; 1.4 mg/min for the SR-PS form with a salt:wax ratio of 3:1; 1.3 mg/min for the SR-PS form with a salt:wax ratio of 4:1; 1.6 mg/min for the SR-PS form with a salt:wax ratio of 4.5:1; and 1.4 mg/min for the SR-PS form with a salt:wax ratio of 5:1. All of the SR-PS forms showed stable release rates after 75 hours of constant flow.

The SR-PS forms with mixing ratios of 3:1, 4:1, 4.5:1, and 5:1 appeared to stop releasing after 12 days of testing. The SR-PS form with a mixing ratio of 2:1 stopped releasing after 21 days.

Forms were removed from the column and dried to be weighed. Table 1 shows the release efficiency data collected from these tests. Release efficiencies, i.e., salt recovery rates, were calculated by comparing the calculated mass of Na₂S₂O₈ in the forms before testing to the calculated mass loss during testing. Release efficiencies of the forms ranged from 90-100%.

TABLE 1

| Mixing | Measured | Calculated | % Released |
|---|---|---|---|
| Ratio | Mass Loss (g) | Mass of Salt (g) | 100 |
| 2:1 | 16 | 15.9 | 90 |
| 3:1 | 23.97 | 26.5 | 99 |
| 4:1 | 35.04 | 35.3 | 98 |
| 4.5:1 | 33.2 | 33.8 | 98 |
| 5:1 | 36.19 | 36.8 | 98 |

Estimated amounts of accumulated S₂O₈²⁻ released based on measured release rates were compared to the calculated S₂O₈²⁻ mass based on stoichiometric estimations to evaluate the error of the accumulated release estimations. This comparison is presented in Table 2.

TABLE 2

| Mixing | Calculated | Accumulated | % |
|---|---|---|---|
| Ratio | Mass of S₂O₈²⁻ (g) | Release of S₂O₈²⁻ (g) | Error |
| 2:1 | 12.9 | 13.4 | 4.3 |
| 3:1 | 21.4 | 23.8 | 10.2 |
| 4:1 | 28.5 | 22.3 | 27.9 |
| 4.5:1 | 27.3 | 27.6 | 1.3 |
| 5:1 | 29.6 | 31.6 | 6.1 |

The results show that the tested SR-PS forms provided a steady and reliable source of oxidants over a duration of 12 days. This stable release can be used to maintain optimal oxidant concentrations to effectively treat organic pollutants in storm water.

The release rates of the tested SR-PS forms were also compared to observe the relationship between the mixing ratios (salts:wax) and the release rates. Table 3 shows the average attenuated release rates for each form.

TABLE 3

| | Peak | | | | % Released |
|---|---|---|---|---|---|
| | Release | % Released | Attenuated Release | | During |
| Mixing | (mg | During | mg (min⁻¹) | | Attenuated |
| Ratio | min⁻¹) | Peak | Average | Std Dev | Period |
| 2:1 | 3.02 | 3.63 | 0.41 | 0.19 | 83.6 |
| 3:1 | 6.31 | 3 | 1.43 | 0.51 | 77.0 |
| 4:1 | 12.6 | 6.59 | 1.32 | 0.64 | 66.5 |
| 4.5:1 | 17.35 | 7.75 | 1.61 | 0.64 | 66.8 |
| 5:1 | 35.38 | 10.9 | 1.39 | 0.63 | 57.4 |

Regression analyses show that there is a moderate correlation between the amount of S₂O₈²⁻ in the SR-PS form with respect to mixing ratio and average release rate (correlation coefficient of 0.79, p value=0.11). These results indicate that there is a positive linear trend of increasing release rate with increasing S₂O₈²⁻ to wax ratio in the SR-PS forms.

### Experiment 7

Column flow-through testing was also performed to evaluate the efficacy of a base-activated SR-PS treatment scheme (e.g., SR-PS+SR-OH) for removing organic pollutants in solution, as well as the effect of SR-HP on such a scheme. Previous studies have shown that persulfate (S₂O₈²⁻) can be activated to create sulfate radicals (SO₄^{-}) and hydroxyl radicals (OH^{}) when the solution becomes basic (See Liang et al., 2007; Furman et al., 2009; Furman et al., 2010). The reaction pathway of S₂O₈²⁻ after dissolution shows S₂O₈²⁻ reacting with water and hydroxide (OH⁻) to create peroxomonosulfate (SO₅²) and sulfate (SO₄²⁻) (Eq.3). Peroxomonosulfate continues on in a reaction with OH⁻ in which it yields hydroperoxide (HO₂⁻) and SO₄²⁻ (Eq. 4). The summation of these two equations yields a net reaction which shows S₂O₈²⁻ degrading in the presence of OH⁻ into HO₂⁻ and SO₄²⁻ (Eq. 5) (Furman et al., 2010).

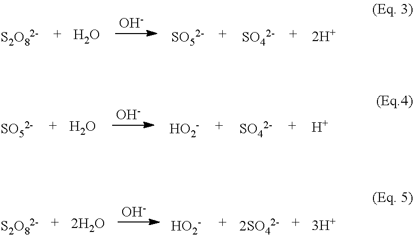

Remaining S₂O₈²⁻ ions react with the HO₂⁻ created in Eq. 3 to create SO₄²⁻, and SO₄^{-} as the HO₂⁻ is oxidized to superoxide (O₂^{•-}) (Eq. 6).

S₂O₈²⁻+HO₂⁻→SO₄^{-}+O₂^{-}+H⁺ (Eq. 6)

When Equations 5 and 6 are added together, the net reaction shows S₂O₈²⁻ in the presence of OH⁻ yielding SO₄²⁻, SO₄^{-} and O₂^{•-} as products (Eq. 7). Additionally, when the solution is in alkaline conditions, SO₄^{-} can react with OH⁻ in solution to create OH^{} (Eq. 8).

2S₂O₈²⁻+2H₂O→3SO₄²⁻+SO₄^{-}+sO₂^{-}+4H⁺ (Eq. 7)

SO₄^{-}+OH⁻→SO₄²⁻+OH^{} (Eq. 8)

In order to evaluate the effectiveness of a base-activated SR-PS treatment scheme, a total of 2 SR-PS, 2 SR-HP, and 2 SR-OH forms were prepared for use during associated proof of concept tests. In this manner, a combination of the SR-PS and SR-OH forms, as well as a combination of the SR-PS and SR-OH forms in further combination with the SR-HP forms, could be evaluated. The forms were allowed to release salt until stabilization (after ˜100 hours).

Column flow-through tests were first performed to evaluate the efficacy of the base-activated SR-PS (i.e., SR-PS+SR-OH) to remove organic pollutants in solution. Initial tests were performed with solutions of BTEX, MTBE, and PAH analytes in deionized water to test the efficacy of base-activated SR-PS in removing organic pollutants. Pollutant solutions were made to have concentrations of 2,000 μg/L for BTEX and MTBE and between 200 and 2000 μg/L for the PAHs to ensure that the concentrations were well above the detectable limits of the laboratory methods. The resulting molar ratios of S₂O₈²⁻ to the analytes were 24:1 for MTBE, 82:1 for Benzene, 132:1 for Toluene, 219:1 for Ethylbenzene, 63:1 for Xylene, 718:1 for Acenaphthalene, 226:1 for Acenaphthylene, and 237:1 for Naphthalene.

Additionally, these tests were conducted to evaluate the effect of inorganic ions and natural organic matter present in storm water on removal rates of organic pollutants, as sulfate may impede SO₄^{-} generation in accordance to Le Chatelier's Principle since the reaction produces SO₄²⁻ (Eq. 5). Storm water collected during rain events was used to simulate the chemical composition of water likely to be found in urban runoff. However, since said storm water did not have detectable amounts of organic pollutants, standard solutions of BTEX, MTBE, and PAHs were added to simulate polluted storm water runoff.

The effectiveness of pollutant removal as demonstrated through the flow-through tests using SR-PS and SR-OH in deionized water are shown in FIG. 12—both with and without the addition of hydrogen peroxide. Average stable release rates for the SR-PS and SR-OH forms were 0.68 and 0.30 mg/min, (3.6×10⁻³ and 1.8×10⁻² mmol/min), respectively. The resulting molar ratio of OH⁻:S₂O₈²⁻ ions in water was 4.9:1, which is comparable to the ratios used in literature (See e.g., Furman et al., 2010).

However, no significant removal of BTEX or MTBE was seen during this test while certain PAHs—notably Acenaphthalene and Acenaphthylene—were removed at an amount of up to 50%. The non-removal of BTEX and MTBE is likely due to the slow generation of SO₄^{-}. Furman et al. (2010) reported that the generation of SO₄^{-} is approximately 3.3×10−3 mM/min. Therefore, it is concluded that to optimize the effectiveness of base-activated SR-PS for storm water treatment, radical generation should be made to occur faster.

Generation of SO₄^{-} is directly related to the creation of hydroperoxide (HO₂⁻) (Furman et al., 2010). In a system with OH⁻ (SR-OH) and S₂O₈²⁻ (SR-PS) acting solely as the reagents for radical generation, S₂O₈²⁻ is used as both a source of SO₄^{-} and HO₂⁻, thus limiting the amount of S₂O₈²⁻ that is usable for radical generation. In order to increase SO₄^{-} formation, it is determined that hydrogen peroxide (H₂O₂) should be added to the solution. Hydrogen peroxide breaks down into HO₂⁻ in alkaline solutions (Eq. 9—Payne et al., 1961).

H₂O₂+OH⁻→H₂O+HO₂⁻ (Eq. 9)

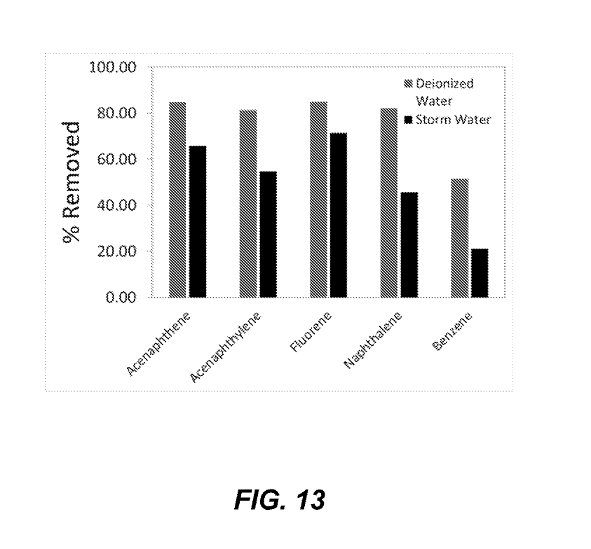

Results from the proof of concept tests using the SR-PS and SR-OH forms in combination with the SR-HP forms are indicated in FIG. 13 (deionized water). The molar ratio of S₂O₈²⁻:H₂O₂ was 1.8:1 and the ratio of OH⁻:S₂O₈²⁻ was 3.5:1 for these tests. Also, the molar ratios of S₂O₈²⁻ to each detectable analyte were 24:1 for MTBE, 82:1 for Benzene, 132:1 for Toluene; 219:1 for Ethylbenzene, 63:1 for Xylene, 916:1 for Acenaphthene, 405:1 for Acenaphthylene, 4,983:1 for Fluorene, and 528:1 for Naphthalene. These molar ratios are comparable to the molar ratios shown in previous studies to yield significant removal of pollutants which were 100:1 for BTEX and 533:1 for Naphthalene (Liang et al. 2008, 2010).

The above-stated ratios were maintained throughout the experiment by the stable release of oxidant salt from the slow-release forms. These ratios can be recreated with any concentration of target pollutant by increasing or decreasing the mixing ratios and the number of slow-release forms in the treatment system.

Removal rates of BTEX and Naphthalene were much higher than those of the system without added H₂O₂ (removal efficiencies: 40-60%). All detectable analytes showed increased removal rates except for Acenaphthylene. This increase in removal efficiency is likely due, at least in part, to an increase of SO₄^{-} due to the addition of OH⁻.

The SR-PS and SR-OH forms used for these tests were also manufactured to have higher release rates than the SR-PS and SR-OH forms used in the above-described experiment that did not include the addition of hydrogen peroxide. Particularly, the average release rates of the SR-PS, SR-OH, and SR-HP forms during this latter test were 0.8 mg/min, 0.3 mg/min, and 0.1 mg/min (4.1×10⁻³, 1.8×10⁻², and 3.5×10⁻³ mmol/min), respectively. It is believed that the higher release rates of these forms also contributed to the increase in analyte removal efficiency—demonstrating that removal rates may be improved by optimizing the release rates of SR forms according to the pollutants levels and runoff discharge of the specific situation. That is, embodiments of the invention may be used to provide target-specific treatment.

Hydrogen peroxide concentration in effluent samples before and after the addition of the SR-OH form to the column showed that H₂O₂ in solution was reacting to create HO₂⁻. SR-HP concentration values were stable at 22 mg/L. Samples taken after the addition of the SR-OH form showed an average concentration of 4 mg/L. This drop in concentration is not likely due to a decrease in release but rather the decomposition of H₂O₂ into HO₂⁻ because of stable concentration values prior to the test. Sulfate generation is optimal at a S₂O₈²⁻ to HO₂⁻ ratio of 1:1 (Furman et al., 2010), thus the SO₄ concentration is proportional to the amount of HO₂⁻ which is indicated by the amount of H₂O₂ difference before and after the system became basic.

Removal rates of MTBE did not change with the addition of H₂O₂. This may be due to the slow degradation kinetics of MTBE in the presence of SO₄. For example, Chen et al. (2009) showed that even at a S₂O₈²⁻ to MTBE molar ratio of 500:1, complete removal of MTBE took over 70 days. BTEX removal for this test is comparable to results found in the literature (Liang et al. 2008). In the presence of SO₄, between 40% and 60% of BTEX was removed. Once this point is reached, the reaction stagnates. The results of this test suggest that BTEX and several PAHs, including Naphthalene, were effectively removed.

### Experiment 8

In order to evaluate the ability of exemplary SR-AOP systems to treat storm water runoff, baseline sampling was performed at a selected storm pipe outlet during rain events. Careful planning was done to ensure that samples were collected during the first flush of runoff water through the storm pipe. Water velocity was determined using a flow meter during each sampling time. A tape measure was used to determine the height of the water and ultimately the cross sectional area of the water in the pipe. The samples were kept in refrigeration until sample preparation for analysis was done. Samples were taken and analyzed for total organic carbon (TOC), total petroleum hydrocarbons (TPH), MTBE, PAH, and BTEX concentrations. All chemical analyses were conducted by Pace Analytics using EPA method 8260, 8270, 5310C, 9038, and SM 4500-CI-E for BTEX/MTBE, PAHs, TOC, SO₄²⁻, and Cl⁻ concentrations, respectively.

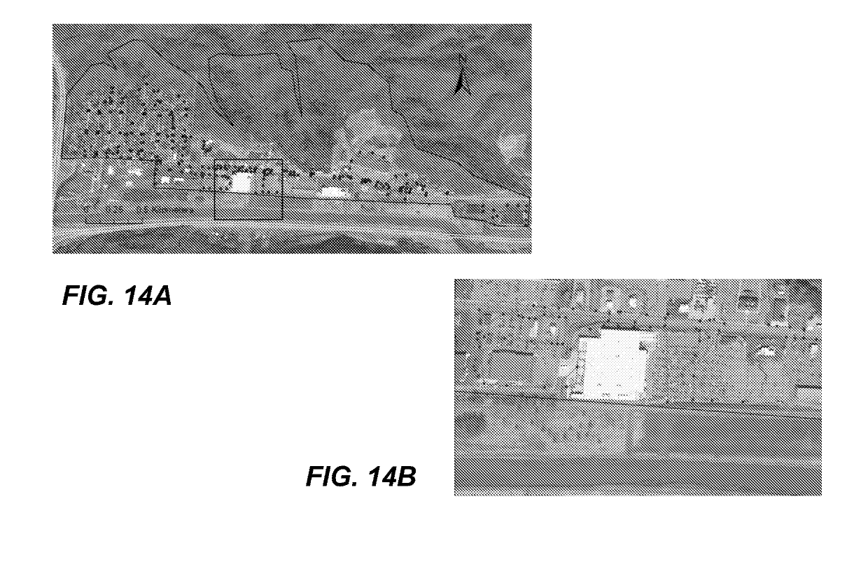

The chosen site for field baseline testing was a largely impermeable area within the city limits of Athens, Ohio. The area has storm drains which receive surface runoff from many impermeable surfaces including roads and parking lots for department and/or grocery stores, gas stations, and a car dealership which has a service station on the premises. The many storm drains mix into a 54 inch cement culvert which runs underneath East State Street until it curves and goes underneath a parking lot and then empties out at the Hocking River. The drainage basin is 3.1 ft²×10⁷ ft², with 9.0 ft²×10⁶ ft² (29%) of that area being impermeable. FIGS. 14A and 14B show the drainage basin and field site for this experiment.

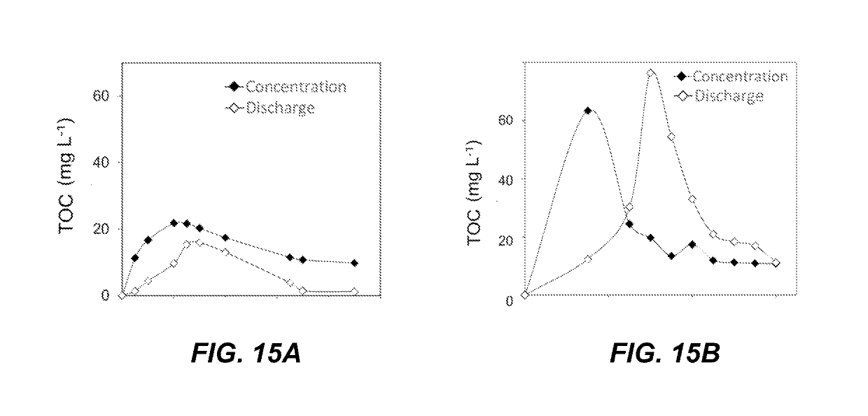

The results of two baseline sampling events are represented in FIGS. 15-17, which show the discharge and chemical load data retrieved from samples collected from two separate storm events. The first storm event occurred on Sep. 16, 2013, beginning at 4:50 am and ending at 6:15 am EST (2.54 mm). The second storm event occurred on Oct. 7, 2013, beginning at 12:15 am and ending at 1:00 am EST (12.44 mm). Sampling was performed during the first hour of each storm event when water flow through the outlet of the storm drains occurred.

As shown in FIGS. 15A, 16A and 17A, the discharge flow rate of runoff from the monitored storm pipe fluctuated from about 0 L/s to about 45 L/s (0 to 4.5×10⁻² m³/s) during the first storm event. As shown in FIGS. 15B, 16B and 17B, the discharge flow rate of runoff from the monitored storm pipe fluctuated from about 0 L/s to about 191 L/s (0 to 1.9×10⁻¹ m³/s) during the second storm event.

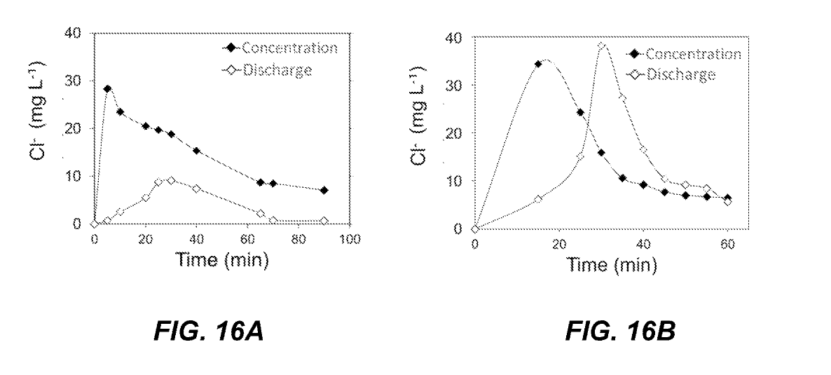

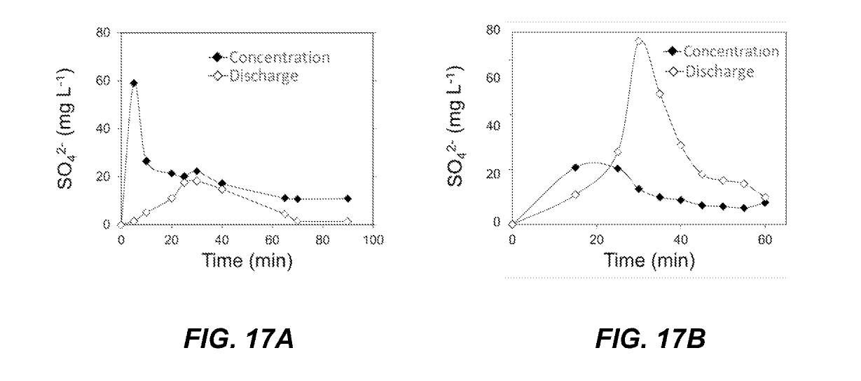

The concentration profiles of TOC present in the runoff are shown in FIGS. 15A and 15B, with FIG. 15A representing the TOC concentration produced by the first storm event and FIG. 15B representing the TOC concentration produced by the second storm event. The runoff discharge data of FIGS. 15A and 15B is presented along with corresponding Chloride (Cl⁻) concentration data for each storm event in FIGS. 16A and 16B, and along with corresponding SO₄²⁻ concentration data for each storm event in FIGS. 17A and 17B.

Concentrations of MTBE, BTEX, PAHs, and TPH in the storm runoff were below the detectable limits, i.e., 4 μg/L for MTBE, 5 μg/L for BTEX, 0.1-1 μg/L for PAHs, and 200 μg/L for TPH. However, detectable amounts of total organic carbon (TOC), SO₄²⁻, and Cl⁻ were present in the runoff from both storm events. The results suggest that there is a relationship between chemical concentration and discharge. Peak chemical concentration occurs prior to peak discharge, which suggests that that the first flush for chemical concentration occurs before peak discharge.

FIGS. 15A-17A and 15B-17B evidence a rapid increase in discharge—peaking at about 45 L/s and 195 L/s, respectively—and then a decrease in discharge to about 5 L/s and 35 L/s, respectively. From FIGS. 15A and 15B, it can be observed that TOC concentration peaked at about 22 mg/L and 64 mg/L, respectively, and then decreased to about 10 mg/L and 11 mg/L, respectively—with an apparent peak within the first hour of the storm event. These profiles are indicative of the first flush event during which the largest amount (˜80%) of the chemical load in storm water runoff is present (See e.g., Tsihrintzis et al., 1997). The Cl⁻ and SO₄²⁻ concentration data respectively presented in FIGS. 16A-16B and 17A-17B also supports the first flush phenomenon, as the peak concentrations (35 mg/L and 60 mg/L, respectively) both precede the respective peak discharge rates. It is also noted that prior to sampling, there was no flow out of the storm drain. Therefore, any accumulated pollutants would have been swept up in the rain event and presented within the first hour of flow with concentrations maximizing at peak discharge events.

### Experiment 9

Flow-through tests were also conducted using storm water collected from rain events. Standard solutions of organic pollutants were added to the storm water to simulate the removal efficiency of SR-PS in storm sewer pipes. Measured concentrations of SO₄²⁻, Cl⁻, and TOC in the storm water were 18 mg/L, 15.1 mg/L, and 492 mg/L, respectively. Results from the flow through proof of concept test using a storm water solution are shown in FIG. 13 (storm water). Toluene, Ethylbenzene, and Xylene were excluded due to instrument interference. The molar ratio of S₂O₈²⁻:H₂O₂ was 1.8:1 and the ratio of 0H⁻:S₂O₈²⁻ was 3.5:1. The ratio of S₂O₈²⁻ to Acenaphthene was 916:1; to Acenaphthylene was 405:1; to Fluorene was 4,983:1, to Naphthalene was 528:1, and to Benzene was 82:1.

All detectable analytes were shown to have oxidized by between 13% and 36%. This suggests that the SR-PS scheme can effectively remove organic pollutants from urban runoff within a short reaction time (˜>10 min) when using a storm pipe system as a reactor.

The results of Experiment 1 (batch oxidation testing) indicates that PS/Fe and Fenton-type agents (e.g., PS/HP/Fe, HP/Fe) are efficient in quickly (within 5 to 10 minutes) oxidizing organic compounds. The results of Experiment 2 (SRS release testing) demonstrate that a slow-release system may be used to efficiently supply oxidants and iron to a fast-flowing water runoff in a controlled and persistent manner. The results of Experiment 3 (flow-through treatment testing) demonstrate that up to 91% of the BTEX and naphthalene pollutants can be oxidized by a SR-PS/Fe scheme within approximately 20 minutes of contact time with the runoff water in which they are entrained.

The results of the additional experiments showed, without limitation, that a base-activated persulfate slow-release AOP system (e.g., SR-PS+SR-OH+SR-HP) is efficient for treating organic pollutants within the estimated average residence time of storm water within storm pipes. For example, it was determined that up to 60% of the pollutants added to a storm water sample were removed by the SR-PS/HP/OH system within 30 minutes of reaction time.

Considering the possible diversity of the sources of NPS pollutants in urban runoff, as well as the reactivity of said pollutants, the installation of SR-AOP forms in storm drains at multiple locations may be an efficient distribution scenario. One exemplary embodiment of such a distribution is illustrated by the black circles in FIGS. 14A and 14B, which indicate various inlets to storm pipes of a storm water collection system. The forms used in such a distribution scenario may be one or more of a PS, PS/Fe, PS/HP, PS/HP/Fe, or PS/HP/OH slow-release form, or some combination of such slow-release forms. Alternatively, water runoff may be treated with only SR-HP/Fe (Fenton's reagent) forms. Still alternatively, a combination of SR-HP/Fe forms and PS, PS/Fe, PS/HP, PS/HP/Fe or PS/HP/OH slow release forms may be used.

While certain exemplary embodiments of the present invention are described in detail above, the scope of the invention is not to be considered limited by such disclosure, and modifications are possible without departing from the spirit of the invention as evidenced by the following claims:

What is claimed is:

1. A slow-release method of treating non-point source pollutants in water runoff as said runoff travels through a storm sewer system, comprising:
providing at least one slow-release advanced oxidation process (SR-AOP) form comprised of a water soluble salt dispersed within a matrix;
placing the at least one form in at least one or more inlets of the storm sewer system; and
causing runoff water to contact the at least one form as it flows through the storm sewer system so as to at least partially oxidize the pollutants in the runoff water by slowly releasing an amount of the water soluble salt thereto.

2. The method of claim 1, wherein the water soluble salt is selected from one or more of the group consisting of a salt of sodium persulfate, ferrous sulfate heptahydrate, sodium percarbonate, sodium hydroxide, potassium permanganate, and sodium permanganate.

3. The method of claim 1, wherein the at least one SR-AOP form includes a base-activated persulfate form.

4. The method of claim 3, further comprising placing at least one hydrogen peroxide form in combination with the at least one base-activated persulfate form.

5. The method of claim 1, wherein the at least one SR-AOP form comprises a combination of at least one persulfate form and at least one hydroxide form.

6. The method of claim 5, further comprising placing at least one hydrogen peroxide form in combination with the at least one persulfate form and at least one hydroxide form.

7. The method of claim 1, wherein the matrix is comprised of paraffin wax.

8. The method of claim 1, wherein the matrix is comprised of a resin.

9. The method of claim 1, wherein the matrix is comprised of a mixture of non-reactive sediments such as silica sands and wax or resin.

10. The method of claim 1, wherein the pollutants to be treated are one or more of the group consisting of any oxidizable organic pollutants such as polycyclic aromatic hydrocarbons, benzene, toluene, ethylbenzene, xylene, methyl tertiary butyl-ether, and metals.

11. A slow-release method of treating non-point source pollutants in water runoff with advanced oxidation processes (AOPs), including Fenton's reagent, as said runoff travels through a storm sewer system, comprising:
providing a first slow-release AOP form including sodium percarbonate and sodium persulfate dispersed within a matrix;
providing a second slow-release AOP form comprised of a matrix having dispersed therein one or more materials selected from the group consisting of ferrous sulfate heptahydrate, zero-valent iron, and other salts that produce reduced iron upon dissolution in water;
placing at least one first slow-release AOP form together with at least one second slow-release AOP form in at least one or more inlets of the storm sewer system; and
causing runoff water to contact the first and second slow-release form(s) as the water flows through the storm sewer system, thereby producing at least sulfate, and hydrogen peroxide and reduced irons (Fe⁰, Fe²⁺) that combine to produce Fenton's reagent, the sulfate and Fenton's reagent acting together to at least partially oxidize the pollutants in the runoff water.

12. The method of claim 11, wherein the first slow-release AOP form further includes one or both materials selected from the group consisting of potassium permanganate and sodium permanganate, which materials are also dispersed within the matrix

13. The method of claim 12, wherein the use of potassium permanganate and/or sodium permanganate results in additional AOPs that contribute to the oxidation of the pollutants in the runoff water.

14. The method of claim 11, wherein the first form and the second form are located in a common container.

15. The method of claim 14, wherein the common container is a water permeable bag.

16. A slow-release Fenton's reagent, comprising:
a first slow-release form having sodium percarbonate dispersed within a matrix; and
a second slow-release form having iron dispersed within a matrix;
wherein, the first slow-release form and the second slow-release form are located in close proximity to one another so that, when concurrently exposed to a flow of water to be treated, the first slow-release form will slowly release hydrogen peroxide and the second slow-release form will supply reduced iron that will activate the hydrogen peroxide to produce Fenton's reagent.

17. The slow-release Fenton's reagent of claim 16, wherein the first slow-release form and the second slow-release form are located in a common water permeable container.

18. A method of treating non-point source pollutants in water runoff using slow-release advanced oxidation process (SR-AOP) agents as said water runoff travels through a storm sewer system, comprising:
providing a combination at least one persulfate SR-AOP form, at least one hydroxide SR-AOP form and at least one hydrogen peroxide SR-AOP form;
placing the combination of forms in at least one or more inlets of the storm sewer system; and
causing runoff water to collectively contact the combination of forms as it flows through the storm sewer system so as to at least partially oxidize the pollutants in the runoff water by slowly releasing persulfate, hydroxide and hydrogen peroxide thereto.

19. The method of claim 18, wherein each of the SR-AOP forms is comprised of a water soluble salt dispersed within a matrix.

20. The method of claim 19, wherein the matrix is comprised of paraffin wax.

21. The method of claim 19, wherein the matrix is comprised of a resin.

22. The method of claim 19, wherein the matrix is comprised of a mixture of non-reactive sediments such as silica sands and wax or resin.

23. The method of claim 18, wherein the at least one persulfate SR-AOP form includes a base-activated persulfate.

24. The method of claim 1, wherein the pollutants to be treated are one or more of the group consisting of any oxidizable organic pollutants such as polycyclic aromatic hydrocarbons, benzene, toluene, ethylbenzene, xylene, methyl tertiary butyl-ether, and metals.

25. A slow-release advanced oxidation process water treatment system, comprising:
a first slow-release form having sodium persulfate dispersed within a matrix;
a second slow-release form having sodium hydroxide dispersed within a matrix; and
a third slow-release form having hydrogen peroxide dispersed within a matrix;
wherein, all of the slow-release forms are located in close proximity to one another so that, when concurrently exposed to a flow of water to be treated, the first slow-release form will slowly release persulfate, the second slow-release form will supply hydroxide ions to encourage the formation of sulfate radicals, and the third slow release form will supply hydrogen peroxide to enhance sulfate radical formation.

26. The system of claim 25, wherein the first slow-release form, second slow-release form, and third slow release form are located in a common water permeable container.

27. The system of claim 25, wherein the matrix is comprised of paraffin wax.

28. The system of claim 25, wherein the matrix is comprised of a resin.

29. The system of claim 25, wherein the matrix is comprised of a mixture of non-reactive sediments such as silica sands and wax or resin.

30. The system of claim 25, wherein the first, second and third slow-release form are all located in a common water permeable container.
